(19) United States
(12) Patent Application Publication
(10) Pub. No.: US 2013/0333892 A1
(43) Pub. Date: Dec. 19, 2013

(54) Acidizing materials and methods and fluids for earth formation protection

(71) Applicant: Guy L. McClung, IV, Spring, TX (US)

(72) Inventor: Guy L. McClung, IV, Spring, TX (US)

(21) Appl. No.: 13/815,494

(22) Filed: Mar. 5, 2013

Related U.S. Application Data
(60) Provisional application No. 61/634,853, filed on Mar. 6, 2012.

(51) Int. Cl. E21B 43/26; C09K 8/68

(52) U.S. Cl. CPC E21B 43/26; C09K 8/68
USPC 166/308.3

(57) ABSTRACT

Fluids for use in operations involving wellbores and/or earth formations, the fluids including formation protective materials for application to an interior surface of earth and/or of a formation and/or of a fracture and/or of a fluid channel of a fracture; acidizing materials and methods; and, in certain aspects, materials for protecting an earth formation so that acid in acidizing fluids does not cause undesirable formation erosion and/or so that unprotected areas are eroded more than protected areas. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATION

The present invention and application claim priority under the patent laws from U.S. application Ser. No. 61/634,853 filed Mar. 6, 2012; which application is incorporated fully herein.

### BACKGROUND OF THE INVENTION

1. Field of the Invention

The present invention is directed to fluids used for formation protection, and acidizing fluids with formation protective materials therein; formation acidizing materials and methods; to such methods which protect earth formations into which acidizing fluids are introduced; to methods for selectively locating and/or extending a fracture and/or a fluid channel thereof; and to fluids with additives for protecting an earth formation.

2. Description of Related Art

The permeability of a subterranean reservoir that is penetrated by a well can be acidized to enable fluids to flow more easily into or out of the reservoir via the well. Fluids flowing into the well can be various fluids that are injected into the well for the purpose of enhancing the recovery and/or flowability of desired hydrocarbons. Fluids flowing out of a well can typically include the desired production fluids. Many rock formations that contain hydrocarbon reservoirs may originally have a low permeability due to the nature and configuration of the reservoir rock. Other reservoirs may become plugged or partially plugged with various deposits due to the flow of fluids through them, particularly drill-in fluids and/or completion fluids.

Acidizing techniques include “matrix acidizing” procedures and “acid-fracturing” procedures. In acid fracturing the acidizing fluid is disposed within the well opposite the formation to be fractured. Thereafter, sufficient pressure is applied to the acidizing fluid to cause the formation to break down with the resultant production of one or more fractures therein. An increase in permeability thus is effected by the fractures formed as well as by the chemical reaction of the acid within the formation.] Matrix acidizing can increase or restoring the permeability of a subterranean reservoir. is acidizing, sometimes called “matrix acidizing,” which facilitates the flow of formation fluids, including oil, gas or a geothermal fluid, from the formation into the wellbore; or the flow of injected fluids, including enhanced recovery drive fluids, from the wellbore out into the formation. Such acidizing involves injecting into the reservoir various acids, such as hydrochloric acid and other organic acids, in order to dissolve portions of the reservoir rock or deposits to increase fluid flow through the formation. Pore throats and other flow channels in the rock are opened and enlarged by the acid, resulting in an increase in the effective porosity or permeability of the reservoir. In certain matrix acidizing processes, acidizing fluid is passed into a formation from a well at a pressure below the breakdown pressure of the formation and an increase in permeability is effected primarily by the chemical reaction of the acid within the formation with little or no permeability increase being due to mechanical disruptions within the formation as in fracturing.

In various carbonate formations including limestones, dolomites or other reservoir rocks that contain substantial amounts of calcareous material, acid fracturing can involve the injection of an aqueous acid solution into the wellbore at a rate and pressure sufficiently high to fracture the surrounding formation. Acid etching of the fracture walls provides conductive channels when the fracture closes.

In certain known hydraulic fracturing processes, a fluid is pumped into a zone of interest in an earth formation at a pressure high enough to overcome the reservoir pressure and pressure transmitted by the overburden to a point where the rock within the formation fractures. After initiation of a fracture, additional quantities of fracturing fluid can be pumped into the formation to extend and widen the fractures. Proppants pumped in quantities of fluid, e.g., in gradually increasing quantities in a fracturing fluid can remain within the fracture so that a permeable channel is provided for formation fluid.

In certain prior known methods, attempts have been made to control the rate of acidization in carbonate reservoirs. U.S. Pat. No. 2,059,459 mentions that hydrochloric acid tends to be spent before it penetrates any significant distance into the reservoir and its rapid and violent reaction tends to develop insoluble fine solids that impair permeability. The patent suggests injecting both a nonaqueous fluid capable of forming or releasing an acid and a water or brine that ensures that release. U.S. Pat. No. 2,301,875 suggests using an aqueous buffer solution of a weak acid and a weak acid salt which has a relatively high pH and a relatively low rate of reaction due to the low hydrogen ion concentration. U.S. Pat. No. 2,863,832 suggests improving the process of U.S. Pat. No. 2,059,459 by injecting only an oil solution of an organic acid anhydride that forms the acidizing solution in situ without injecting any water. U.S. Pat. Nos. 3,215,199; 3,297,090; and 3,307,630, suggest injecting a hydrolyzable organic halide, such as a halogenated hydrocarbon or ether, mixed with a solvating medium, such as water, to form hydrochloric acid by an in situ solvolysis reaction.

U.S. Pat. No. 3,441,085 suggests slowly acidizing a carbonate reservoir by (a) injecting a weak acid or a weak acid solution which is so concentrated that the rate of acidization is impeded by the amount of salts which are precipitated from the concentrated solution, and (b) subsequently injecting water or brine to dissolve the precipitated salts and cause further acid acidization and acid penetration.

U.S. patent application Ser. No. 813,014, filed Jul. 5, 1977 describes a process for slowly acidizing a reservoir that contains siliceous and/or argillaceous materials. An aqueous solution containing salts of both hydrofluoric and chlorocarboxylic acids is injected so that a mud acid is formed within the reservoir. The chlorocarboxylate ions are hydrolyzed to yield an acid that reacts with the fluoride ions so that a clay-dissolving mud acid is formed. U.S. Pat. No. 4,122,896 mentions methods in which carbonate materials within a subterranean reservoir are acidized at a selected relatively slow rate by injecting into the reservoir a substantially acid-free aqueous solution of a chlorocarboxylic acid salt, so that the rate at which the acidization proceeds is limited to substantially the rate at which an acid is formed by the hydrolysis of the chlorocarboxylate ions.

A difficulty encountered in the acidizing of a formation (e.g., but not limited to dolomites, limestones, dolomitic sandstones, etc.) is caused by a rapid reaction rate of the acidizing fluid with those portions of the formation with which it first comes into contact; e.g., in fracture acidizing where pressures, high formation temperatures, and high acid solubility limit the amount of formation that can be contacted by unreacted (“live”) acid before it spends on the formation rock. As the acidizing fluid is forced from the well into the propagating fracture, the acid reacts rapidly with the calcareous material immediately adjacent to the fracture and the acid becomes spent before it penetrates into the formation a significant distance from the fracture.

For example, in fracture acidizing of a limestone formation, it is common to by-pass vugs (cavities or pores) as the fracture often propagates too fast to interconnect with the vugs. Therefore, the porosity of the vuggy formation is not sufficiently increased because many of the vugs are not interconnected. As a result, hydrocarbonaceous fluids contained in the vugs are not removed and the formation or reservoir is not sufficiently drained. This, of course, severely limits the increase in productivity or injectivity of the well. In order to increase penetration, it has been proposed to add a reaction inhibitor to the acidizing fluid. For example, in U.S. Patent there is disclosed an acidizing process in which an inhibitor, such as alkyl-substituted carboximides and alkyl-substituted sulfoxides, is added to the acidizing solution. Another technique for increasing the penetration depth of an acidizing solution is that disclosed by U.S. Pat. No. 3,076,762 wherein solid, liquid, or gaseous carbon dioxide is introduced into the formation in conjunction with the acidizing solution.

U.S. Pat. No. 5,238,067 proposes a method for improved fracture acidizing in a carbonate containing formation. Initially, the formation is hydraulically fractured via a wellbore thereby forming a hydraulic fracture. Thereafter, an acid sufficient to dissolve the carbonate containing formation is introduced into the fracture where it etches the fracture's face which causes channels to form therein. Next, a viscous fluid containing a diverting material sufficient to prevent fracture growth is directed into the fracture and this material temporarily closes off existing areas of the fracture which precludes additional fluid from entering these areas. Subsequently, hydraulic fracturing is again commenced via the wellbore into the existing fracture whereupon fracturing forces by-pass areas which have been precluded from receiving additional fluid flow by the diverting material. Thus, the fracturing forces are directed away from the first fracture into an area of the formation which has not been previously fractured.

Problems have been encountered in such acidizing operatons due to undesirable effects on the earth formation by the acids used in the processes. These problems can include: maintaining formation integrity to withstand well treatment fluids, e.g. fluids used in fracturing, acidizing, gravel packing or cleanup; closure of formed conductivity pathways due to a well treatment, e.g., through fracturing or acidizing; a change of decrease in formation hardness and accompanying loss of formation integrity which can cause a collapse of open fluid flow channels; and fines migration, which can occur during or after fluid well treatments.

### SUMMARY OF THE PRESENT INVENTION

The present invention, in certain aspects, discloses fluids used in well operations (e.g., drilling, completion, fracturing, injection, production) that contain formation protective materials (“FPM”), e.g. water soluble metal salts and other materials disclosed herein, which are applied to or “coat” interior surfaces of an earth formation and, in one particular aspect, the interior surfaces of fractures and/or of fluid channels in fractures to inhibit or prevent damage to or deterioration of the earth formation, e.g., but not limited to, damage from acid in acidizing fluid which can detrimentally erode or eat way the formation.

In certain methods according to the present invention, formation protective materials—“FPMs”—are combined with a fluid and introduced into an earth formation to be applied to earth of the formation. “Combined with” includes any known way or method for mixing, blending, preparing, making into solution, sonicating, stirring and/or agitating (or combination thereof) the FPMs with another material or materials (e.g., water, liquid, slurry, solution, vapor, gas or mixtures thereof). “Introduced into” includes any known way of flowing the FPMs and locating the FPMs within an earth formation, including, but not limited to, injection and pumping, e.g., in a known fluid introduced into the earth in any known way, e.g., but not limited to, in drilling, injection, fracturing, testing, workover, completion, flushing, and treating. “Applied to” includes, but is not limited to, stick to, adhere to, coat, be absorbed into, react with, agglomerate onto, be held by, and rest on and “applying to” or “coating” as used herein for any embodiment of the present invention may refer to encapsulation, forming a film on a surface, simply to changing the surface by chemical reaction, or by forming or adding a thin film of the material on a surface. “Formation protective materials” may be added to or included with fluids used in well operations (including, but not limited to, oil wells, gas wells, injection wells, geothermal wells) oil and gas operations, fluids e.g., but not limited to, drilling fluids, treatment fluids, workover fluids, fracturing fluids, flushing fluids, slickwater fluid, water-based fluids, drilling mud, cements, completion fluids, slurries, injection fluids, matrix treatment fluids, hydraulic fracturing fluids, stimulation fluids, isolation fluids, drill-in fluids, water-base fluids, pneumatic fluids, non-water-base fluids, remediation fluids, suspensions, mixtures, emulsions, fluids with viscosfiers, fluids with proppants, and brines and combinations thereof.

The present invention, in certain aspects, discloses an acidizing fluid that contains formation protective materials (“FPM”), e.g. water soluble metal salts, which coat the interior of fractures in an earth formation to inhibit or prevent acid in acidizing fluid from detrimentally eating way the formation or eroding it and/or to produce unprotected areas which the acid preferentially attacks. In one aspect, such FPMs act as a sacrificial barrier that is eaten away by acid and which reduces the amount of earth formation material eroded by the acid, for example, but not limited to, carbonates in the earth.

The term “applying to” or “coating” as used herein for any embodiment of the present invention may refer to application onto earth, encapsulation of earth, forming a film on an earth surface such as an interior surface of earth, changing earth surface by chemical reaction, or by forming or adding a thin film of material on an earth surface. Without being bound to any theory, it is believed that in such “coating” water soluble materials or compounds bond to a formation forming a barrier or mass that can inhibit or prevent unwanted damage to the formation to occur during and once acidizing has taken place and/or during the formation of flow channels in a fracture.

Acidizing methods which are improved according to the present invention include: damage removal acidizing; acidizing for the completion and stimulation of horizontal wells; matrix acidizing; and fracture acidizing. It is within the scope of the present invention to treat a formation with the protective materials according to the present invention and then, subsequently, to pump an acidizing fluid into the formation; or, alternatively, to include the formation protecting materials with the acidizing fluid itself. Within the scope of “formation protecting materials” according to the present invention include: suitable water-soluble metal salts that can protect an earth formation and impede, inhibit or prevent undesirable acid erosion or eating away of the formation, cationic metal salts, water-soluble aluminum salts, aluminum chloride, aluminum chlorohydrates, chloroaluminate, zirconium chlorides, zirconium tetrachloride, zirconocene dichloride, zirconium (III) chloride, zirconium salts and aluminum zirconium tetracholorhydrex glycine (e.g., in solid form to be added to a fluid or in solution).

In certain aspects, formation protective materials are introduced into an earth formation for application to less than all of a fracture's interior surfaces or less than all of the interior surface of a fluid flow channel. In certain aspects, a sufficient amount of FPMs is introduced so that relatively prominent parts or portions of a fracture or flow channel are protected, leaving uncoated areas therebetween (“valleys” and/or “troughs,” e.g, between “ridges” or “projections”) to and through which acid can flow and act to etch a path or area. In other aspects, partial areas of a fracture's, surface have FPMs applied thereto so that acid subsequently introduced acts on the unprotected areas to form enhanced flow channels for the flow of hydrocrabons. In other aspects, partial areas of a flow channel's surface have FPMs applied thereto so that acid subsequently introduced acts on the unprotected areas to form enhanced flow channels for the flow of hydrocrabons. Optionally, before the introduction of FPMs, formation blocking material is applied to a formation surface and then the FPMs are introduced; or a first application of FPMs is done and then a subsequent application of FPMs covers less surface than was covered by the initial application so that acid has more effect on areas protected only by the FPMs of the initial application. Optionally, between multiple applications of FPMs to a particular earth formation, fracture or fluid flow channel, sufficient time is allowed to elapse so that applied FPMs are in place and stable and/or flushing and/or stabilizing fluids are introduced before a subsequent application of additional FPMs.

The present invention discloses, in certain embodiments, methods for forming fluid conductivity channels in an earth formation which provide desired fluid conductivity, e.g., conductivity of desired recoverable hydrocarbons, and which are formed with an acidizing method according to the present invention that includes coating with protective materials the interior surfaces of fractures in which fluid channels are made. Such methods in certain aspects are methods for increasing the productivity of wells completed in soft acid-soluble producing formations, and include: producing in such formation a fracture with interior surfaces; and coating the interior surfaces with formation protective material or materials.

Methods according to the present invention include creating one or more fractures in an earth zone of interest; coating the interior surface of all or part of the fracture(s) with formation protective material(s); causing the fracture(s) to close; and injecting acid into and through the closed fracture(s) so that flow channels are formed therein. The fracture(s) are then extended; extended portions are, optionally, coated; fracture(s) are caused to close; and acid is injected through previously formed flow channels and through the extended portions of the fracture(s) so that flow channels are formed in the extended portions. These steps are repeated until fractures having flow channels formed therein are extended desired distances in the zone.

Optionally, according to the present invention, any flow channel produced by acid may have its interior surfaces coated with FPMs. Optionally, any surface of any fracture and any surface of any acid-made flow channel in any method according to the present invention may be coated with FPMs to reduce friction along such a surface so that fluid flowing adjacent such a coated surface flows more easily and less impeded by frictional contact with the surface. In addition to the FPMs disclosed herein for formation protection, for the purpose of reducing friction, any suitable friction reducing material or substance may be used for the friction-reducing function. In certain aspects, the materials and methods of the present invention are used in formations which are acid-soluble and have a Brinell hardness above 15, above 20, between 15 and 40, or between 40 to 60.

In any embodiment of the present invention, the formation protective material may be provided in a solution, in a mixture, in solid material added to a fluid, or in a slurry. In one aspect a mixture or a slurry of carrier fluid compatible with the chosen formation protective material includes the formation material. The slurry is pumped into a formation alone or with another fluid, e.g., but not limited to, with a treatment fluid, a fracturing fluid, or with an acidizing fluid. In one aspect, the fracturing fluid includes any suitable known fracturing fluid with the formation protective material therein.

In certain aspects, the present invention provides methods of treating a formation with a well treatment fluid that includes a clay stabilizer and formation protective materials. In one aspect the clay stabilizer is any suitable known clay stabilizer; and in other aspects, the clay stabilizer is a polyamine ether, e.g., as disclosed in U.S. Pat. No. 8,020,617 which is fully incorporated herein for all purposes. These methods according to the present invention are useful before or during a well treatment such as, but not limited to, cleanup, gravel packing, fracturing, or the like. The stabilizer and/or formation protective materials can continue to inhibit fines migration in a treatment zone even after an aqueous fluid without the stabilizer, e.g. a production fluid or injection fluid, displaces the original treatment fluid, in one aspect, with formation protective materials remaining in place on the formation surfaces. The stabilizer may be used in a viscoelastic system (VES). The stabilizer may be used with an acid blend component. The formation protective materials in this aspect (and in any embodiment herein) may be used in a viscoelastic system (VES).

The present invention provides methods for combining formation protective fluids and surfactants; e.g., mixing formation protective materials with viscoelastic surfactant fluids in appropriate amounts, including, e.g., suitable surfactants such as anionic, cationic, nonionic and/or zwitterionic surfactants.

In certain aspects, the present invention provides drilling methods using drilling fluid with formation protective materials therein, e.g., in drilling fluids used to form boreholes in shale or clay deposits which are also stabilized using various shale stabilizers, e.g., polyamines and polyol compounds used to stabilize water-sensitive solids during drilling operations.

In certain embodiments of the present invention, a fluid with formation protective materials is used with a clay stabilizer to inhibit fines migration during completion, stimulation or other post-drilling well operations and methods. In one embodiment, fines inhibition can be on a permanent or essentially permanent basis so that formation damage does not occur for a period of time after removal of the treatment fluid from the treatment zone of the formation and introduction of a displacement fluid. In one embodiment, a viscoelastic surfactant viscosifies the treatment fluid containing the formationprotective materials and the stabilizer, e.g. using an acid pH modifier.

In certain aspects, these methods further include hydraulically fracturing the formation, placing gravel adjacent the formation, removing scale from adjacent the formation, removing mud cake from adjacent the formation, and/or treating the formation between drilling and gravel placement, and/or a combination thereof. In one embodiment, the treatment fluid is a prepad or preflush in an operation to treat the formation. In one embodiment, (and as is true for any method herein) the method can include soaking the treatment zone in contact with the treatment fluid for a desired time period, e.g, a period of at least thirty minutes, of at least one hour, of at least two hours, and of at least a day.

In certain embodiments, the treatment fluid can be prepared by mixing the clay stabilizer and the formation protective materials with an aqueous medium.

In the development of any actual embodiment of the present invention, numerous implementation-specific decisions can and often must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

In the summary of the invention and in the descriptions herein, each numerical value should be read once as modified by the term “about” (unless already expressly so modified), and then read again as not so modified unless otherwise indicated in context. Also, in the summary of the invention and the detailed descriptions, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors have disclosed and enabled the entire range and all points within the range.

As used herein, a reservoir is a permeable fluid-containing region of a formation in fluid communication with a wellbore via a treatment zone of interest wherein reservoir fluid can be depleted by producing reservoir fluid to the wellbore, accumulated by injection of fluid into the reservoir, e.g. by injection via the wellbore, sometimes by displacement and/or permeation of fluid through the treatment zone, or a combination thereof. Depletion of a reservoir fluid is known as production, whereas accumulation of fluid into the reservoir, i.e. negative production, is known as injection. This invention relates to fluids and methods used to treat a subterranean formation, and in particular, the invention relates to the use of formation protective materials to protect interior surfaces of formation and/or of fluid flow channels of formations and/or of fractures.

In certain aspects, FPMs are combined with a fluid, the FPMs present in an amount sufficient to achieve the protection of a desired surface of an earth formation, fracture, of flow channel. In one aspect, the ratio of FPMs to other material or fluid is 0.1 to 1000; in certain aspects, a ratio of 0.1 gallons to 1000 gallons; in certain aspects, a ratio of between 0.1 and 0.5 FPMs to 1000 other material; in certain aspects, a ratio of between 0.1 and 0.5 gallons FPMs to 1000 gallons other material; in certain aspects, a ratio of 1:1000; in certain aspects a ratio of 1 gallon of FPMs to 1000 gallons of other material; in certain aspects a ratio of between 0.1 to 2.0 of FPMs to 1000 of other material; in certain aspects a ratio of between 0.1 to. 2.0 gallons of FPMs to 1000 gallons of other material; in certain aspects, a ratio of between 0.25 and 0.50 FPMs to 1000 other material in certain aspects, a ratio of between 0.25 and 0.50 gallons FPMs to 1000 gallons other material. In certain aspects a gallon of aqueous FPM fluid according to the present invention has, by weight, FPMs present as a weight percent: in a range of between 10 to 60 weight percent; a range of 30 to 50 weight percent; a range of 35 to 40 weight percent; about 32 weight percent; about 35 weight percent; and about 40 weight percent—for all of these the remainder water and/or other suitable fluid or fluids. In certain aspects, such an aqueous FPM fluid mixture is present in a ratio of 0.5 gallon to 1000 gallons of fracturing fluid or other fluid. In certain aspect FPMs are present in a ratio by weight of between 1 pound to 20 pounds of FPms to 1000 pounds of other material; or in a ratio of 10 pounds FPMs to 1000 pounds other material.

In any embodiment of any method disclosed herein, the formation protective materials may be present in any desired amount or concentration; e.g., in various embodiments hereof, the formation protective materials can be present in an amount of from about 0.01 g/L of fluid (0.1 lb/1000 gal of fluid (ppt)) to less than about 7.2 g/L (60 ppt), or from about 0.018 to about 4.8 g/L (about 1.5 to about 40 ppt), from about 0.018 to about 4.2 g/L (about 1.5 to about 35 ppt), or from 0.018 to about 3 g/L (1.5 to about 25 ppt), or even from about 0.24 to about 1.2 g/L (about 2 to about 10 ppt. from 0.01 to 0.4 percent by weight of a fluid, from 0.025 to 0.2 percent by weight of a fluid, or at a rate within a range of from any lower limit selected from 0.0001, 0.001, 0.01, 0.025, 0.05, 0.1, or 0.2 percent by weight of a liquid phase, up to any higher upper limit selected from 1.0, 0.5, 0.4, 0.25, 0.2, 0.15 or 0.1 percent by weight of the liquid phase. A fluid in one embodiment with formation protective materials may contain FPMs from about 1% to about 10% by volume based upon total fluid volume 100%.

In certain aspects, a treatment fluid according to the present invention with formation protective materials therein is pumped into a treatment zone of interest. In an embodiment, the treatment fluid is pumped sufficiently above the reservoir fluid pressure to enter the treatment zone. In embodiments, the treatment fluid can be above or below a fracture initiation pressure. In embodiments, the wellbore is cased or open hole adjacent the treatment zone. In embodiments, the contacted treatment zone extends radially from the wellbore for a minimum distance equal to at least about 1, 2, 3, 5, 10, 50 or even about 100 wellbore diameters. In an embodiment, the treatment zone is soaked in the treatment fluid for a period of time effective to apply the FPMS to protect formation surfaces, such as for example, a few minutes to several days or more. In embodiments, the treatment fluid-treatment zone contact time is at least from a lower limit of 5, 10, or 30 minutes, or at least from 1, 2, 4, 8, 12, 24, 48 or 72 hours, and in other embodiments is within a range from any lower limit up to a higher upper limit of 1 week, 3 days, 2 days or 24, 12, 8, 4, 2 or 1 hour. In an embodiment, during the life of the well, the treated zone can be unsusceptible to water damage, especially near the wellbore, or in one embodiment at least less susceptible to water damage relative to the same zone in the absence of the treatment. In a production well, the reservoir fluids passing through the treatment zone may contain water; in an injection well, the injected fluids may contain water.

Regardless of the intended use, a treatment fluid according to the present invention with FPMs therein can be prepared at any time prior to use by combining the fluid components. FPMS can be hydrated by mixing with water at the wellsite or provided in a prehydrated form. A polymer, when used, can be hydrated by mixing with water at the wellsite or provided in a prehydrated form, as is known in the art. The viscoelastic surfactant, when used, can be provided in an aqueous solution, but also can be provided in any other form. A high density brine carrier fluid can be prepared by the addition of the inorganic salt to the carrier fluid any time before, during, or after addition of the viscoelastic surfactant to the fluid. Additives to be included in the fluid can be added to the fluid at any time prior to use or even added to the fluid after it has been injected into the wellbore.

In certain aspects in methods according to the present invention a formation is treated with formation protective materials after or in advance of production and/or injection. Such a treatment may be a stand alone treatment of a formation treatment by itself rather than as a preflush or post flush in conjunction with another well treatment procedure. In one aspect in a stand alone treatment embodiment, the treatment fluid with FPMs and, optionally with a shale inhibitor, and optionally also comprising a brine such as KCl or TMAC or another clay stabilizer, is pumped into the treatment zone of interest before initiating reservoir fluid production and/or water or steam injection via the wellbore. In an embodiment, the treatment fluid is pumped below the fracture initiation pressure but sufficiently above the reservoir fluid pressure to enter the treatment zone. After a sufficient soak, the wellbore is used for production or injection as desired.

In certain aspects, the present invention provides formation treatment for formation protection either before as a preflush or during as a part of a stimulation treatment procedure, for example, fracturing, acidizing or the like. As a preflush embodiment, the treatment fluid including FPMs and, optionally, a shale inhibitor, and optionally also comprising a brine such as KCl or TMAC or another clay stabilizer, injected as described above in advance of the stimulation procedure, e.g. in a pad or pre-pad fluid injection stage, with sufficient contact time in the treatment zone to provide formation protection during the subsequent stimulation treatment stages and production or injection.

In certain aspects, the formation protective materials according to the present invention are used with polymers that are commonly used to thicken or otherwise modify the rheology of treatment fluids such as gravel packing and fracturing fluids. For example, in one embodiment, the treatment fluid can include formation protective materials and polymers that are either crosslinked or linear, or any combination thereof. Polymers include natural polymers, derivatives of natural polymers, synthetic polymers, biopolymers, and the like, or any mixtures thereof. An embodiment uses any viscosifying polymer used in the oil industry to form gels. Another embodiment uses any friction-reducing polymer used in the oil industry to reduce friction pressure losses at high pumping rates, e.g. in slickwater systems.

Some non-limiting examples of suitable polymers include: polysaccharides, such as, for example, guar gums, high-molecular weight polysaccharides composed of mannose and galactose sugars, including guar derivatives such as hydropropyl guar (HPG), carboxymethyl guar (CMG), and carboxymethylhydroxypropyl guar (CMHPG), and other polysaccharides such as xanthan, diutan, and scleroglucan; cellulose derivatives such as hydroxyethyl cellulose (HEC), hydroxypropyl cellulose (HPC), carboxymethlyhydroxyethyl cellulose (CMHEC), and the like; synthetic polymers such as, but not limited to, acrylic and methacrylic acid, ester and amide polymers and copolymers, polyalkylene oxides such as polymers and copolymers of ethylene glycol, propylene glycol or oxide, and the like. The polymers may be preferably water soluble. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups, as described published application US 2004209780.

When incorporated in the well treatment or other fluid, the polymers may be present at any suitable concentration, e.g., but not limited to, as disclosed in U.S. Pat. No. 8,020,617 or in references cited in this patent.

Accordingly, the present invention includes features and advantages which are believed to enable it to advance acidizing technology. Characteristics and advantages of the present invention described above and additional features and benefits will be readily apparent to those skilled in the art upon consideration of the following description of preferred embodiments and referring to the accompanying drawings.

Certain embodiments of this invention are not limited to any particular individual feature disclosed here, but include combinations of them distinguished from the prior art in their structures, functions, and/or results achieved.

Features of the invention have been broadly described so that the detailed descriptions of embodiments preferred at the time of filing for this patent that follow may be better understood, and in order that the contributions of this invention to the arts may be better appreciated.

It is, therefore, an object of at least certain embodiments of the present invention to provide the embodiments and aspects listed above, those described below, and:

New, useful, unique, efficient, nonobvious acidizing materials and methods;

New, useful, unique, efficient, nonobvious formation protective materials and methods of their use;

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review, the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

Certain aspects, certain embodiments, and certain preferable features of the invention are set out herein. Any combination of aspects or features shown in any aspect or embodiment can be used except where such aspects or features are mutually exclusive.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1 is a schematic representation of a fracture system formed according to the present invention.

FIG. 2A shows schematically a vertical section across a borehole penetrating a subsurface formation with a fracture system according to the present invention.

FIG. 2B shows on a larger scale than FIG. 2A the section 2B-2B across the fracture formed in the formation.

FIG. 3A is a schematic illustration of a well bore in a subterranean producing zone just after a fracture has been created in the zone.

FIG. 3B is a schematic illustration of the well bore and producing zone of FIG. 3A after the fracture has been caused to close and with interior surface of the fracture coated with formation protective material.

FIG. 3C is a schematic illustration of the well bore and producing zone of FIG. 3B after an acid has been injected through the closed fracture and flow channels have been formed therein.

FIG. 3D is a schematic illustration of the well bore and producing zone of FIG. 3C after the originally formed fracture has been extended.

FIG. 4A is a schematic illustration of a well bore in a subterranean producing zone just after a fracture has been created in the zone.

FIG. 4B is a schematic illustration of the well bore and producing zone of FIG. 4A after the fracture closed.

FIG. 4C is a schematic illustration of the well bore and producing zone of FIG. 4B with part of an interior surface of the fracture coated with formation protective material

FIG. 4D is a schematic illustration of the well bore and producing zone of FIG. 4C after an acid is injected through the closed fracture and flow channels have been formed therein.

FIG. 5 is a schematic illustration of a well bore in a subterranean producing zone after fractures have been created in the zone.

FIG. 6 is a schematic diagram of a system for acid well operations according to the present invention.

FIG. 7A is a schematic diagram of a system for operations according to the present invention.

FIG. 7B is a schematic diagram of a system for operations according to the present invention.

FIG. 7C is a schematic diagram of a system for operations according to the present invention.

FIG. 8A is a schematic crossection view of a part of an underground earth formation with a passage therethrough.

FIG. 8B shows the schematic crosssection of FIG. 8A with formation protective material applied to some of the passageway's interior surface according to the present invention.

FIG. 8C shows the results of fluid etching on the passageway of FIG. 8B according to the present invention.

Any combination of one or some aspects and/or of one or some features described above, below, in independent claims, or in dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness. As used herein and throughout all the various portions (and headings) of this patent, the terms “invention”, “present invention” and variations thereof mean one or more embodiments, and are not intended to mean the claimed invention of. any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### DETAILED DESCRIPTION OF THE INVENTION

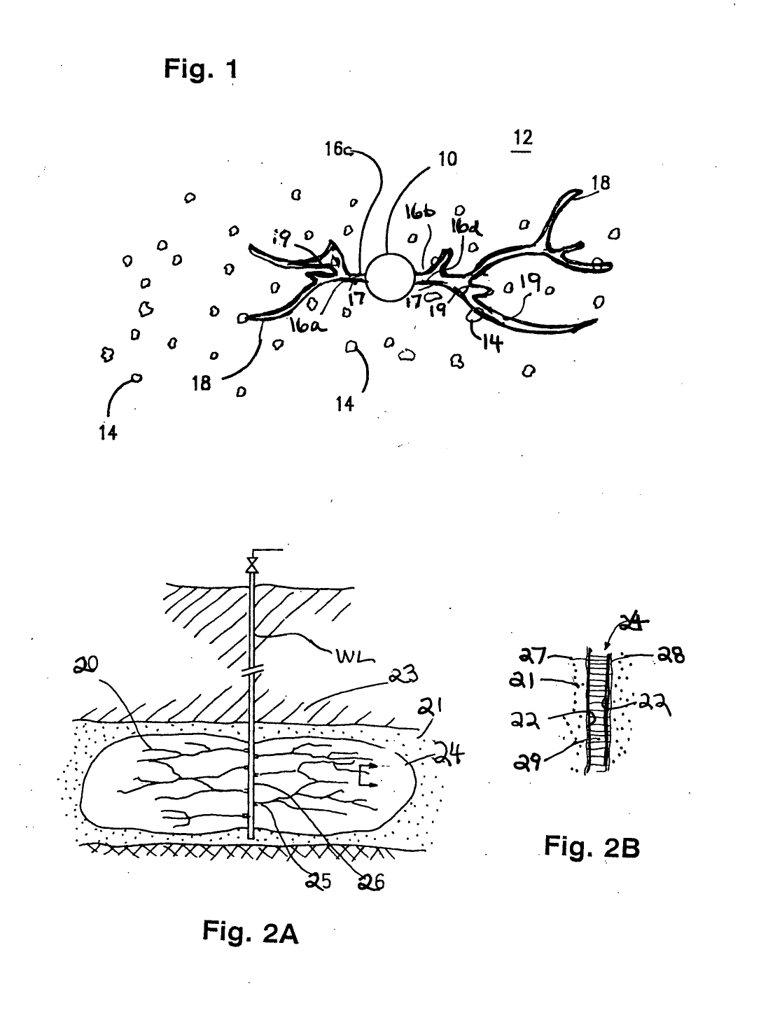

In one method according to the present invention, the methods of U.S. Pat. No. 5,238,067 are improved (and this patent is incorporated fully herein for all purposes). As shown in FIG. 1, hydraulic fracturing is conducted in a wellbore 10 so as to fracture hydraulically the earth formation 12. Any suitable known hydraulic fracturing method or technique may be used, including, but not limited to those in U.S. Pat. Nos. 7,942,201; 7,721,804; 7,934,546; 7,934,556; 7,334,635; 7,886,822; 4,249,609; 5,238,068; 5,238,067; 7,267,171; 7,947,629; 6,207,620; 3,962,102; 8,066,073 4,787,456; 4,478,845; 4,067,389 and in references cited in these patents.

For purposes of illustration, FIG. 1 shows double-winged vertical fractures 16a and 16b emanating from the wellbore 10. Once hydraulic fracturing has been completed to the extent desired, formation protective material is introduced into the fractures and interiors 16c and 16d are coated with the metal salts 17. Acid is then injected into the wellbore 10. The solution of acid employed may be any of the aqueous solutions of acid commonly employed for acidizing subterranean calcareous formation. For example, the solution of acid may be an aqueous solution of any of these acids: Hydrochloric, HCl; Hydrofluoric, HF; Acetic, CH3COOH; Formic, HCOOH;; Sulfamic, H2NSO3H; and Chloroacetic, ClCH2COOH. Inone aspect the acid is hydrochloric acid and aqueous solution of hydrochloric acid is used that contains between 5 and 28% by weight of hydrogen chloride.

Optionally, the solution of acid can employed contain an agent to inhibit the precipitation of materials such as calcium sulfide; e.g., when hydrogen chloride is used, the solution thereof may contain up to 24% by weight of calcium chloride. Also, the solution of acid may contain any of the commonly employed inhibitors for preventing corrosion of metal equipment, tubular, casing, liners, and tubing in or adjacent the well. The amounts of formation protective materials and of acid solution employed will vary according to the size and extent of fracture(s) and distance of fracture(s) from the. These amounts will also vary according to the extent to which the material or formation is to be dissolved or protected. Optionally any suitable known inhibitors may be used.

As the acid moves along the interior faces of the formed fractures, it etches it and forms channels therein. Using known techniques, the fractures may be further diverted in the earth. Branched fractures 18 may be formed and their interior faces may also be coated with formation protective materials (shown as materials 19). In certain methods according to the present invention, fluid conductivity channels are formed in an earth formation which provide desired fluid conductivity, e.g., conductivity of desired recoverable hydrocarbons, and which are formed with an acidizing method according to the present invention that includes pre-coating with protective materials the interior surfaces of fractures in which fluid channels are made. Such methods present improvements to known methods; e.g., but not limited to, methods as in U.S. Pat. No. 4,249,609 which is incorporated fully herein for all purposes. Such methods in certain aspects are methods for increasing the productivity of wells completed in soft acid-soluble producing formations, and include: producing in such formation a fracture with interior surfaces; and coating the interior surfaces with formation protective material or materials.

Then, optionally, such methods may also include: filling the fracture with a viscous fluid; injecting an acid solution into the formation to create acid etched fingering channels wherein the viscosity of the contained fluid is greater than that of the acid solution; injecting into the formation a fluid with a propping agent; in one particular aspect, the viscosity of the propping agent is at least equal to that of the acid solution until the propping agent is deposited in the fracture at least in those areas where channels have been etched; and lowering the pressure within the fracture to allow it to move towards a closed position. Thus long fingering acid etched channels are created and propped such that the channel walls of the soft formation are maintained sufficiently for the creation of effective fluid channels and, when proppants are used, propped open when the fluid pressure in the fracture is reduced.

A formation 21 shown in FIG. 2A is made of chalk containing hydrocarbons in the pore space thereof, which hydrocarbons are to be produced via a borehole or well WL which penetrates the chalk formation 21 as well as an overlying formation 23. The well WL is completed with typical equipment that is normally used for that purpose.

A vertical fracture 24 is formed in the formation around the well WL by injecting a fracturing fluid into the formation. This fluid is passed from the interior of the well WL into the pore space of the formation s1 via perforations 25 that have been shot in casing 26 of well WL. The fluid is injected at a pressure adapted for fracturing the formation 21.

Viscous fluid may be used for the fracturing; and also non-viscous fluids may be applied for fracturing the formation in the method according to the present invention. When using a non-viscous fracturing fluid (which may contain fluid-loss preventing agents), a viscous fluid may be subsequently injected into the fracture formed by the non-viscous fluid which is thereby displaced from the fracture.

Certain viscous fracturing fluids that may be used in the present method do not contain acid components in amounts that are suitable for etching appreciable parts of the walls of a fracture. Relatively small amounts of acids, however, may be present, such as required for breaking the viscosity of the fluid after a predetermined period when the fluid pressure in the fracture has been released. Examples of viscous fluids that may be used in these methods are gelled water, hydrocarbon-in-water emulsions, water-in-hydrocarbon emulsions, and gelled hydrocarbons.

A viscosity breaker may be added to the viscous fluid, which breaks the viscosity of this fluid after a predetermined time interval, either under influence of the temperature prevailing in the fractured formation, or by a retarded chemical reaction, or by any other mechanism. Such viscosity breakers are known per se, and need not be described in detail. The same applies for the fracturing fluid (either viscous or non-viscous), the viscosifying agents and fluid-loss preventing agents that are optionally incorporated therein, and the injection pressures which have to be used to induce a fracture. Any of the fracturing fluids used in the present method may contain fluid-loss preventing agent.

Interior walls of the fracture 24, after being induced, are coated with formation protective materials 22. The fracture is kept open by supplying viscous fluid thereto at a sufficiently high pressure. Walls 27 and 28 of the fracture 24 (see FIG. 2B which shows an enlarged detail of a section of FIG. 2A) are thus kept at a distance of several millimeters from one another, and the space between these walls contains the viscous fluid 29.

Subsequently, an acid solution is pumped down the well under a pressure at which the solution will enter the fracture 24 and keep the walls thereof separated from each other. The solution enters the fracture 24 through perforations 25 in casing 26, which perforations are distributed over that part of the casing 26 which faces the oil-producing part of the formation 1.

By a suitable choice of the composition of the fracturing fluid, the original viscosity thereof is substantially maintained at least over the period during which the acid solution is being injected into the fracture that contains the viscous fracturing medium. The acid is injected at a pressure sufficiently high to prevent closing of the fracture 24. Displacement of the viscous fluid results in a so-called “fingering” of the acid solution through the viscous mass of the fluid.

A plurality of perforations 25 may be used in the vertical casing 26 which are arranged at vertically spaced levels over that portion of the casing facing the oil-containing formation 21, resulting in a plurality of fingering flow paths 20 of the acid through the viscous fluid present in the fracture 24. The fingering paths 20 followed by the acid solution and originating from the perforations 25 form the base of a channel system that is subsequently being etched in the walls 27 and 28 of the fracture 24 by the action of the acid solution on the material of the walls during the continued injection of the acid into the fracture 24.

A large variety of acids, either inorganic or organic, are available which are capable of etching the particular formation that is to be treated by the method of the invention. For etching a chalk formation, use may be made of aqueous solutions of hydrochloric acid, acetic acid, formic acid or mixtures thereof. Retarders may be added to such solutions if considered necessary. To protect the equipment in the borehole or well 22, corrosion inhibitors may be added to the solution. In an alternative manner, solutions may be used wherein the acid is formed in situ in the formation, e.g., but not limited to, by using a retarded chemical reaction. After the channels have been etched to an appreciable depth, the injection of the acid solution is stopped and, optionally, a fluid carrying a propping agent is injected down the well 21 through the perforations 25 and into the fracture 24. Since a propping agent is incorporated in the carrying fluid, the fracture 24 is filled with propping agent over substantially its full height.

Injection of the carrying fluid with propping agent is continued until a dense packing of propping agent is present in the fracture 24. The interior walls of the channels are supported by the particles of the propping agent present therein and will not collapse during the closing action of the walls. The channel system that has been etched in the walls of the fracture 24 will thus remain open after the fluid pressure within the fracture has been allowed to fall below the fracturing pressure.

The invention is not restricted to the use of any particular composition of viscous fluid, acid solution, carrying fluid or propping agent. Any composition of viscous fluid and acid may be used to practice the invention. The methods according to the present invention may be used effectively in acid-soluble formations having a Brinell hardness lower than 15, above 15, in the range of 15-25, of about 40, and in the range of between 15 and 40, or between 40 to 60. Buffer fluids may be injected into the formation.

Certain methods according to the present invention include: creating one or more fractures in a subterranean zone, coating all or part of fracture interior surfaces with FPMs, causing the fractures to close and injecting acid into and through the closed fractures so that flow channels are formed therein. The fractures can be extended in the zone, the extended fractures caused to close and acid is injected through the previously formed flow channels and through the extended portions of the fractures so that flow channels are formed in the extended portions. As desired, the present invention provides coating with FPMs of all or part of fracture surfaces and/or flow channel surfaces to produce flow channels at a desired location, to produce flow channels of a desired length, to produce flow channels of a desired crosssectional area through which a desired volume of fluid can flow, and/or to reduce friction to facilitate fluid flow through fractures and/or flow channels.

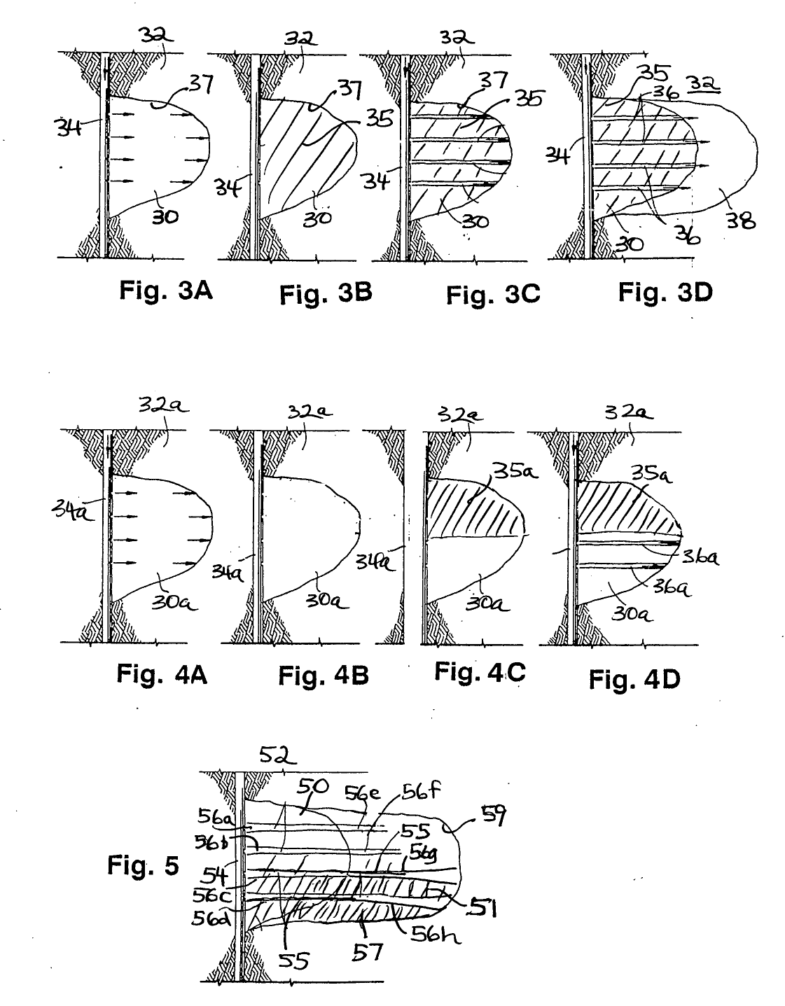

FIG. 3A shows at least one fracture 30 in a subterranean producing zone 32 is created by pumping a fracturing fluid through a well bore 34 into the producing zone 32 at a rate whereby the pressure exerted on the material making up the zone 32 is higher than the fracturing pressure of the material, that pressure at which fractures are induced in a formation, and with continued pumping the fractures are maintained in the open position and extended.

After the fracture 30 is created in the producing zone 32, the fracture 30 is caused to close (FIG. 3B) by reducing the pumping rate of the fracturing fluid whereby the pressure exerted in the zone 32 is below the fracturing pressure. In one technique, the pumping of fluid into the production zone 32 is completely stopped until the pressure dissipates and the fracture 30 is caused to fully close. Optionally, the fluid pumped through the well bore and into the producing zone being stimulated can be all acid containing fluid or it can be alternating quantities of non-acid fracturing fluid and acid containing fluid, with the pumping rate being reduced or stopped between the quantities of non-acid fracturing fluid and acid containing fluid.

Fluid containing formation protective material 35 (indicated schematically by crosshatching) is pumped to the fracture and coats the fracture's surface 37 (see FIG. 3B). Then acid is pumped to the fracture, e.g., at a rate whereby the pressure exerted on the zone 32 is below the fracturing pressure and the fracture 30 remains closed as the acidizing fluid is pumped therethrough and flow channels 36 are etched therein (FIG. 3C).

As shown in FIG. 3D, following the etching of the flow channels 36 in the fracture 30, the fracture 30 can be extended by injecting additional fracturing fluid therein. Inone embodiment, fracturing fluid is then injected through the flow channels 36 in the fracture 30 at a rate whereby the pressure exerted in the zone 32 is again above the fracturing pressure. As a result, the fracture 30 is extended an additional distance outwardly from the well bore forming an extended portion 38 as shown in FIG. 3D.

The fracture 30 including the extended portion 38 is caused to close by reducing or stopping the flow of fluid therethrough and fluid containing acid is then injected through the previously formed flow channels 36 and through the extended portion 38 of the fracture 30 at a rate whereby the pressure exerted in the zone 32 is below the fracturing pressure. As the acid flows through the flow channels 36 and the extended portion 38, the flow channels are widened and additional flow channels are etched in the extended portion 38.

The previously formed flow channels can provide relatively low friction conduits through which fracturing fluid flows, and the extension of a fracture at the ends of the flow channels can be be in all directions, i.e., upward, downward and outward. Coating surfaces (all or part) with FPMs (and with other materials that reduce friction) and pumping acid therethrough can effect flow channels at desired locations and/or of desired dimensions, e.g., but not limited to channels that follow generally horizontal layers of highly acid soluble and/or highly permeable portions of the rock faces of the fracture and/or channels that extend further into a zone than do others. Optionally, the acid injected into a fracture while it may be retarded, unretarded or accelerated depending upon the particular type of rock making up the subterranean formation and other factors. In a preferred technique, unretarded acid is utilized in the originally created fracture with progressively more retarded acid being used to etch flow channels in the extended portion of the fracture.

A variety of conventionally used fracturing fluids may be employed in accordance with the present invention , e.g., but not limited to, aqueous solutions, gelled aqueous solutions aqueous acid solutions, gelled aqueous acid solutions, aqueous emulsions and aqueous acid containing emulsions.

FIGS. 4A-4D illustrate a method according to the present invention similar to that of FIGS. 3A-3D (and similar numerals indicate similar things; e.g., numeral 32a indicates a production zone as does the numeral 32 in FIG. 3A). A shown in FIGS. 4A and 4B, a fracture 30a is produced in a zone 32a using a wellbore 34a.

As shown in FIG. 4C, formation protective material 35a (indicated schematically by crosshatching lines) is applied to a portion of an interior surfaces 37a of the fracture 30a.

As shown in FIG. 4D, the coating of the material 35a inhibits the production of fluid flow channels in the coated part of the fracture and channels 36a are produced in the non-coated part of the fracture.

In addition to the formation protective materials described above, semi-permanent and/or permanent coatings can be applied to all or part of a fracture's surface and/or to all or part of a produced fluid flow channel.

FIG. 5 shows a fracture 50 produced in an earth zone 52 using a wellbore 54 with fluid flow channels 56a-56d made as those in FIGS. 3C or 4D. Following the production of the channels 56, the fracture 50 is extended to include fracture 57. The fluid flow channels 56c and 56d are coated with FPMs 55. Optionally, part of the surface 59 of the fracture 57 is coated with FPMs 51 (shown by crosshatched lines; with or without the interior of the channels 56c and 56d coated). Acid that flows through the original flow channels then makes new channels 56e-56g.

The flow channels 56g and 56h can be wider and longer than the flow channels 56e and 56f due to the effects of the FPMs present within the flow channels 56g and 56h and/or the effects of the FPMs 57 on the fracture surface 59.

The present invention provides new methods for treating a formation penetrated by a wellbore which improve fluid loss control during treatment; and which, in some embodiments, are improvements to the methods disclosed in U.S. Pat. No. 8,066,073. In certain aspects, the treatment methods s include: preparing an aqueous fluid including one or more water inert polymers and an optional viscosifier, injecting the aqueous fluid into the wellbore at a pressure equal to or greater than the formation's fracture initiation pressure, and thereafter injecting into the wellbore a proppant laden fluid at a pressure equal to or greater than the formation's fracture initiation pressure; and, at any suitable desired point in the method, e.g., after any injection step, with the polymers, or with the proppant laden fluid, coating earth formation surfaces with formation protective material(s) according to the present invention, including surfaces of a fracture and/or of a fluid flow channel of a fracture. The water inert polymer, the fluids, and the proppants may be any of these disclosed in U.S. Pat. No. 8,066,073 or in references cited in this patent.

The present invention provides a method of treating a subterranean formation penetrated by a wellbore, comprising: a. preparing an aqueous fluid comprising at least one water inert polymer; b. injecting the aqueous fluid into the wellbore at a pressure equal to or greater than the formation's fracture initiation pressure; c. thereafter injecting into the wellbore a proppant laden fluid at a pressure equal to or greater than the formation's fracture initiation pressure; wherein the water inert polymer forms a film on fracture faces; and d. after step a., before and/or after step b., and/or before or after step c., applying formation protective material to fracture faces. Such a method may include one or some of the following, in any possible combination: degrading any film formed subsequent to injecting the proppant laden fluid; insuring that no viscosifier is added to the aqueous fluid to substantially increase the fluid viscosity; and/or wherein the water inert polymer comprises one or more latex polymers or emulsion polymers or a combination thereof.

Formation protective materials introduced into an earth formation in any method according to the present invention may form a film on fracture faces, and the film may optionally be at least partially degraded before, during and/or subsequent to injecting a proppant laden fluid. Optionally such a film may be degraded with an acid, a breaker, such as a delayed breaker, a conventional oxidizer, an oxidizer triggered by catalysts contained in the film, a latent acid, or formation fluids. Also, the formation protective materials may or may not substantially enter the formation pores. Methods of the invention may use a fluid further including one or more of the following: a gas component, acid particles, colloidal particles, at least one friction pressure reducing agent, and the like. In any fluid in any method herein, a conventional fluid loss additive may or may not be incorporated into the fluid, as well as any other commonly used additives or components.

Although not bound by or limited to any particular theory or mechanism of operation, fluid flow enhancement according to the present invention and fluid flow channel creation in methods disclosed herein may be improved by the use of formation protective materials due to coating and/or film forming on surfaces of earth. For example, a substantially water impermeable film, also referred to as a “membrane” for purposes herein, may be deposited on a fracture face.

Methods of the present invention employing formation protective materials are suitable for treating formations containing petroleum products, such as oil and gas, as well as injection wells. The invention may be practiced in any suitable formation condition.

Friction reducers may also be incorporated into fluids used in the invention. Any suitable friction reducer may be used. Also, polymers such as polyacrylamide, polyisobutyl methacrylate, polymethyl methacrylate and polyisobutylene as well as water-soluble friction reducers such as guar gum, guar gum derivatives, hydrolyzed polyacrylamide, and polyethylene oxide may be used. Commercial drag reducing chemicals such as these sold by Conoco Inc. under the trademark “CDR” as described in U.S. Pat. No. 3,692,676 or drag reducers such as those sold by Chemlink designated under the trademarks “FLO 1003, 1004, 1005 & 1008” have also been found to be effective. These polymeric species added as friction reducers or viscosity index improvers may also act as excellent fluid loss additives reducing or even eliminating the need for conventional fluid loss additives.

In certain embodiments, in methods according to the present invention, a subterranean formation (e.g. gas, oil or water bearing formation) is treated with formation protective materials according to the present invention and is acidized with an emulsion comprising an aqueous acidizing solution, optionally also with an oil and a cationic surfactant which renders oil-containing earthen formations oil-wet; and, in certain aspects, the surfactant is present in the emulsion in an amount which is sufficient to increase the reaction time of the acid acting on the formation.

In certain embodiments of such a method, an acidizing emulsion is prepared containing a cationic surfactant which in the presence of the acid renders oil containing formations oil-wet, an aqueous acidizing solution, and an oil. A sufficient amount of said surfactant is employed to stabilize the emulsion and substantially increase the reaction time of the acidizing emulsion. The acid reacts more with earth formation that has not been treated with formation protective materials; and reacts less with formation that has been so treaetes, to include the interior surfaces of fractures and/or of fluid flow channels of fractures.

The present invention provides methods that include treating an earth formation (including surfaces of a fracture and/or surfaces of a fluid flow channel of a fracture) which employ a fracturing fluid with proppant particulates which are improvements of known methods, including, but not limited to, improvements of the methods of U.S. Pat. No. 7,267,171 which is incorporated fully herein for all purposes. In certain aspects the proppants are at least partially coated with a hardenable resin composition, e.g., a hardenable resin component and a hardening agent component, wherein the hardenable resin component is a hardenable resin and wherein the hardening agent component is a hardening agent, a silane coupling agent, and a surfactant; introducing the fracturing fluid into at least one fracture within the subterranean formation, wherein substantially all or part of the interior of the fracture is coated with formation protective materials according to the present invention; depositing at least a portion of the proppant particulates in the fracture; allowing at least a portion of the proppant particulates in the fracture to form a proppant pack; and, allowing at least a portion of the hardenable resin composition to migrate from the proppant particulates to a fracture face.

In certain methods according to the present invention, part of an earth formation including sandstone (including substantially all or part of the interior surfaces of a fracture and/or of fluid flow channels of the fracture) is treated with formation protective materials according to the present invention, and then an acidizing fluid for sandstone formations is used in the formation to acidize the formation and concurrently inhibit calcium fluoride formation and impart calcium tolerance to the fluid. The acidizing fluid may be any suitable known fluid, including, but not limited to, those provided in U.S. Pat. No. 7,947,629 which is incorporated fully herein for all purposes.

Such an acidizing fluid for acidizing a sandstone formation penetrated by a wellbore can include an aqueous acid treatment which is a mixture of an aqueous liquid, a fluoride source, and an effective amount of at least one homopolymer or copolymer of a polycarboxylic acid, salt thereof or derivative thereof, which is introduced into the wellbore, and allowed to acidize the formation and concurrently inhibit calcium fluoride formation and impart calcium tolerance to the fluid.

In certain aspects, in a method according to the present invention, a fracture is made in a subterranean formation, the subterranean formation being in fluid communication with the surface, the method including: creating a fracture in the subterranean formation, the fracture having an interior surface with fracture faces; protecting fracture faces with formation protective material; and injecting into the fracture an encapsulated formation etching agent, wherein the encapsulated formation etching agent includes a formation etching agent and an encapsulating agent. Such methods provide improvements to those disclosed in U.S. Pat. No. 6,207,620 which is incorporated fully herein for all purposes; and such a method may include any of the subject matter of claims 2-18 of this patent.

In one method according to the present invention an acid-in-oil emulsion with the acid as an internal phase is used with formation protective material in the emulsion so that the formation protective material coats interior surfaces of the formation (e.g., surfaces of a fracture and/or of a fluid channel therethrough). In one aspect, the formation protective material is dispersed throughout the emulsion; and in another aspect, this material is in an external phase of the emulsion. In one aspect, the formation protective material is immiscible with the acid; and, in another aspect, it is miscible. In one aspect in such a method a corrosion inhibitor is added as an external phase of the emulsion, and the corrosion inhibitor prevents downhole corrosion of members downhole, e.g., but not limited to, tubulars, float equipment, packers, cementing equipment, casing, tubing, risers, and pipe,. In certain aspects, such methods are used in acidizing carbonate formations to enhance hydrocarbon recovery. The improvements according to the present invention can be used to improve the methods of U.S. Pat. No. 8,039,422 which is incorporated fully herein for all purposes.

In certain aspects, the present invention provides methods for treating a subterranean formation which include forming a treatment fluid including a carrier fluid with formation protective materials therein. Optionally, the treatment fluid may include a solid acid-precursor, and/or a solid scale inhibitor.

In certain aspects, the method may include performing an acid fracture treatment within the formation; and, optionally, inhibiting scale production within the formation.

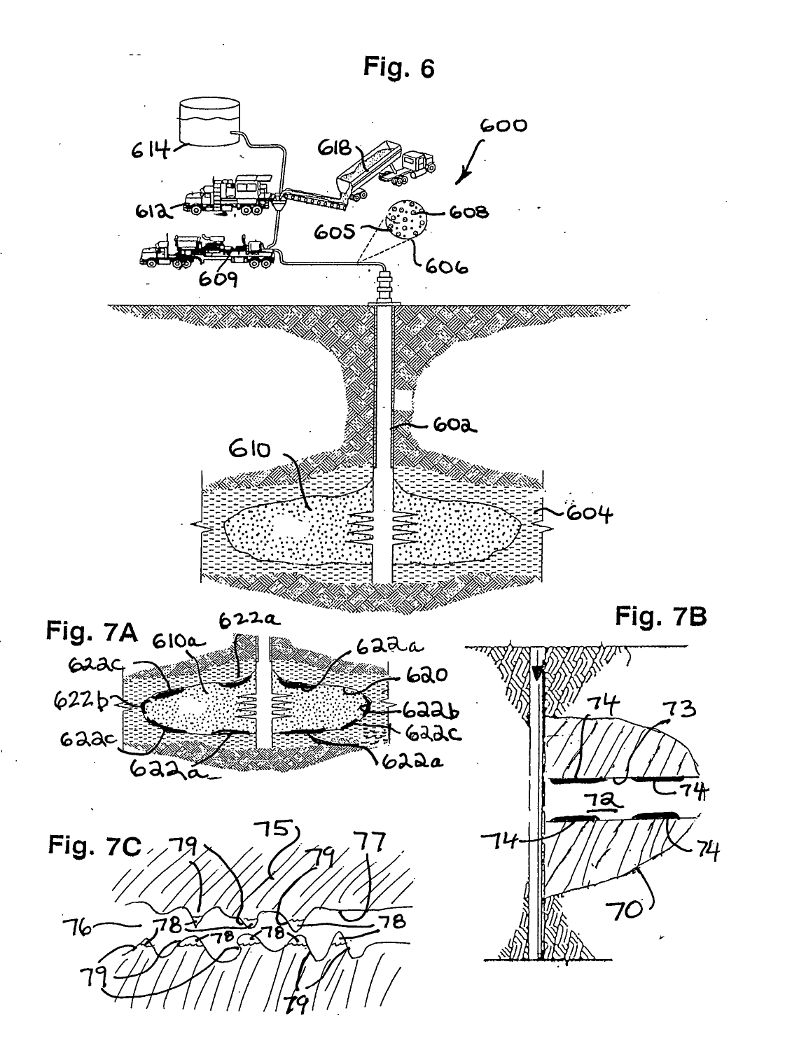

FIG. 6 is a schematic diagram of a system 600 for acid fracturing and, optionally, scale inhibition. The system 600 includes a wellbore 602 intersecting a subterranean formation 604. The subterranean formation 604 may be a hydrocarbon bearing formation, or any other formation where fracturing may be utilized and inhibiting scale formation may be desirable. In certain embodiments, the subterranean formation 604 may related to an injection well (such as for enhanced recovery or for storage or disposal) or a production well for other fluids such as carbon dioxide or water.

In certain embodiments, the system 600 includes an amount of treatment fluid 606. The treatment fluid 606 includes a carrier fluid 605 which includes formation protective material 608 according to the present invention, and, optionally a solid acid-precursor, and/or a solid scale inhibitor. The solid acid-precursor and the solid scale inhibitor may be any known suitable substances or materials, including, but not limited to, those disclosed and referred to in U.S. Pat. No. 7,886,822 and in references cited in this patent.

A blender or mixer 612 can mix or combine fluid from a reservoir 614 with formation protective materials (and/or other materials) from a supply 618 (solids, liquids, solutions, or fluids).

The formation 604 may be a formation that is enhanceable by an acid fracturing treatment, for example a limestone and/or dolomite reservoir, or a reservoir having acid treatable minerals mixed in with other materials such as sandstone.

In certain embodiments, the system includes a pump system 609 to fracture the formation, and to place the treatment fluid 606 into the fracture 610. The formation protective material 608 is applied to or coats interior surfaces of the fracture 610.

The fracture 610 includes an acid fracture, which may be a hydraulically initiated fracture having a fracture face etched with acid, and/or an acid induced fracture. The fracture 610 may include wormholes and/or other flowpaths into the formation 604. The fracture 610 may be propped open with a proppant, or the fracture may retain highly conductive flow paths after closure due to acid etching. In certain embodiments, the fracture 610 retains particulates from the treatment fluid 606 that may not be ordinary proppant, for example particles present may include solid scale inhibitor particles, solid acid-precursor particles, solid acid-responsive material particles, and/or particles that include mixtures of one or more of the preceding

In some embodiments of the invention, formation protective materials and, in certain aspects, a clay stabilizing additive can be added to a treatment fluid such as, for example, a brine used in a gravel pack or in an aqueous medium for use in a fracturing fluid, such that when the treatment fluid leaks off into the formation or is flowed back to the wellbore, the additive has apparently been applied to and/or reacted with the formation mineralogy to tenaciously or permanently protect formation surfaces and to stabilize clays from swelling and movement. Such materials can also inhibit or prevent damage in the reservoir rock that might otherwise occur due to mobilization of fines, i.e. formation permeability damage due to fines migration to block pores. The materials can in one embodiment also be added to a prepad or a preflush in any well treatment operation so that the formation is prepared to receive other aqueous fluids that could otherwise damage the permeability.

In certain aspects, the invention uses treatment fluid with a water carrier or a brine carrier with formation protective materials. The brine sued may be water including an inorganic salt or organic salt, e.g., inorganic monovalent salts including alkali metal halides, and sodium, potassium or cesium bromide, inorganic divalent salts including calcium halides, for example, calcium chloride or calcium bromide, zinc halides, zinc bromide, may also be used. A carrier brine phase may also have an organic salt, sodium or potassium formate, acetate or the like, which may be added to the treatment fluid up to a desired concentration. In certain aspects, a salt used is compatible with the drilling fluid which was used to drill the wellbore, e.g. the salt in the treatment fluid used as a prepad or preflush, or in a completion/clean up fluid, can be the same as the salt used in the drilling fluid; and formation protective materials may be used in such a prepad or preflush or such a completion fluid or clean-ip fluid.

Formation protective fluids may be combined with surfactants, e.g., non-limiting examples of which include those described in U.S. Pat. Nos. 5,551,516; 5,964,295; 5,979,555; 5,979,557; 6,140,277; 6,258,859 and 6,509,301, and in the references in these patents, all hereby incorporated by reference.

Friction reducers may also be incorporated into fluids that include formation protective materials used in the invention. Any suitable friction reducer may be used, e.g., but not limited to, hydoxyethyl cellulose (HEC), xanthan, 2-acrylamido-2-methylpropanesulfonic acid (AMPS), diutan and the like. Also, polymers such as polyacrylamide, polyisobutyl methacrylate, polymethyl methacrylate and polyisobutylene as well as water-soluble friction reducers such as guar gum, guar gum derivatives, hydrolyzed polyacrylamide, and polyethylene oxide may be used. Commercial drag reducing chemicals may also be used. In some embodiments, the fluids with formation protective materials according to the present invention may further include a crosslinker.

In certain aspects, the present invention relates to a method of gravel packing a wellbore. For gravel packing, the fluid in an embodiment has FPMs and, optionally, comprises, in addition gravel and other optional additives such as clay stabilizers, filter cake clean up reagents such as chelating agents referred to above or acids (e.g. hydrochloric, hydrofluoric, formic, cetic, citric acid), corrosion inhibitors, scale inhibitors, biocides, leak-off control agents, among others. The FPMs can be added to the gravel packing fluid containing the gravel, or can be used in a prepad or flush, optionally with a soak, in advance of the gravel stage.

In certain aspects, the present invention provides methods for enhancing the productivity of a subterranean formation penetrated by a well, e.g., a gas, oil or geothermal well, the method including introducing into the formation a fluid which has brine and formation protective materials. In certain particular aspects, the fluid is used in fracturing and in the thermal insulation of production tubing or transfer pipes.

In certain methods, a brine, in one aspect has any desired density; and, in other aspects, a density greater than or equal to 9 ppg; and, in another aspect, has a density between 9 and 19.2 ppg. The brine may be one of or a combination of sodium chloride, potassium chloride, calcium chloride, sodium bromide, calcium bromide, zinc bromide, potassium formate, cesium formate and sodium formate. In one aspect, in such a method, the fluid is a a pumpable polymerizable fluid includes, with the brine, a crosslinkable, monofunctional alkene, multi-functional alkene (such as a difunctional alkene), a heat inducible free radical initiator and brine. The fluid components may be those described in U.S. Pat. No. 7,896,078, and may be present in the amounts and ranges described in the patent.

The present invention provides methods for well completion and workover wherein a subterranean formation in a well is contacted with a treating fluid, the steps including: pumping a treating fluid in the well and contacting the formation with the treating fluid wherein the treating fluid is an aqueous saline solution or brine with formation protective materials; and forming a bridge and/or seal on a portion of the formation to bridge and/or seal it off. In certain aspects (and as may be true for formation protective materials used in any embodiment described herein) the formation protective materials are in a particle size range of about 5 microns to about 800 microns. The treating fluid may formed by dissolving the formation protective materials in water; e.g., in the amount of about 4 pounds to 50 pounds per barrel of brine solution.

FIG. 7A shows a fracture 610a (like the fracture 610 of FIG. 6) which has an interior surface 620 which is not totally coated with FPMs. Only certain areas 622 of the surface 620 have had FPMs applied thereto. These areas 622 will be protected when any subsequent fluid, material, or acid contacts these areas and their erosion. Abrading, wear or eating away will be less than that of the adjacent unprotected areas. The protected areas may be located as desired; e.g., areas 622a near a wellbore; areas 622c on fracture surfaces; and/or areas 622b at fracture ends.

FIG. 7B shows schematically a fracture 70, e.g., as in FIG. 3C, with a fluid flow channel 72 which has an interior surface 73. Formation protective materials 74 protect areas of the surface 73 of the fluid flow channel 72. FPMs may be used on any number of separate areas of the surface 73 with any desired spacing and any desired location.

FIG. 7C shows an earth formation 75 with an opening, channel, or pathway 76 having an interior surface 77 (which is meant to depict, e.g., an interior surface of a fracture or of a flow channel of a fracture). FPMs 78 coat portions of prominences 79 of the surface 77. An etchant, e.g., acid, flowing into the pathway 76 will have more effect on the areas between the coated areas of the prominences 79 than on the coated areas. Either existing valleys or troughs between prominences will be enlarged and/or extended by the acid, or enhanced flow areas will be created between the prominences by the acid.

It is within the scope of the present invention to provide formation protective material on less than the entire surface of a fracture or of a channel in an earth formation. This can be accomplished, e.g., by applying different amounts and/or concentrations of material, by applications at different time intervals and periods, and/or by using encapsulated material (e.g., a mixture of both encapsulated material and non-encapsulated material; a fluid with encapsulated material; and/or such fluids with the mixture or only with encapsulated material applied in times steps). Surfaces that have formation protective material, or surfaces that have relatively more formation protective material than others, will better withstand the effects of etchants such as acids; and etchants will wear away, eat away, and/or erode areas with less protection more than areas with more protection. In certain aspects, this will create deeper and/or longer pathways in the earth, in a fracture, or in a fluid flow channel.

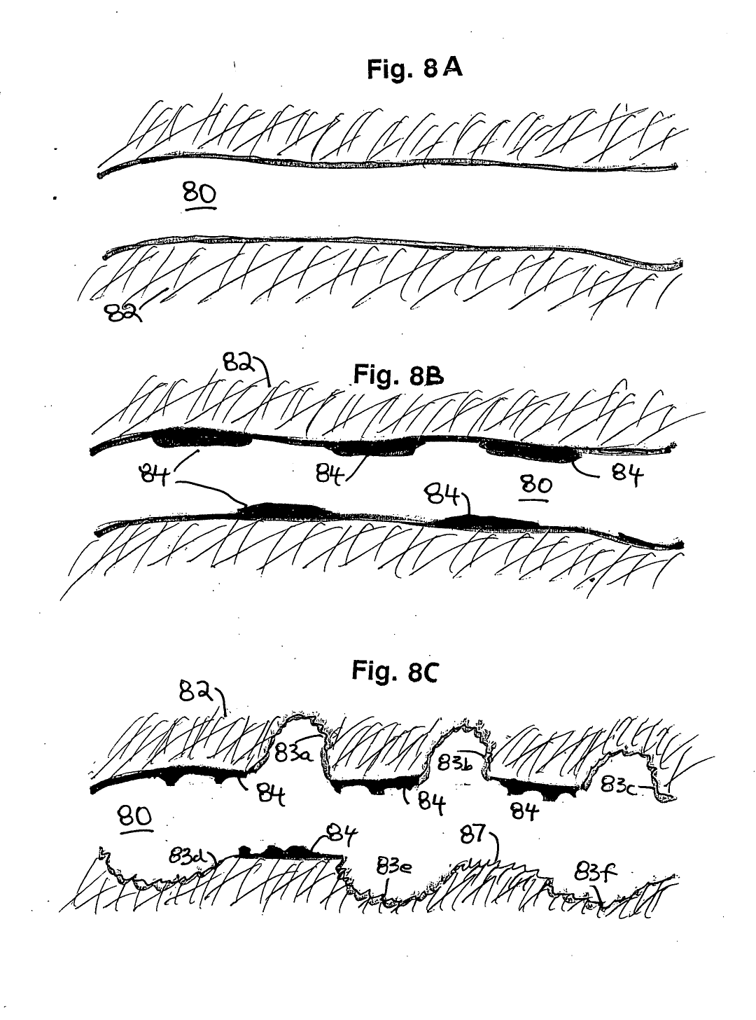

FIG. 8A shows a passageway 80 through an earth formation 82. As shown in FIG. 8B, formation protective material 84 has been applied to certain portions of an interior surface 81 of the passageway 80.

Following the flow of acid (or other etchant) through the passageway 80, flow channels 83a-83f are formed which extend from passageway surface portions that were unprotected by material 84. Either the material 84 is diminished, or an area protected therewith is not as eroded as surface areas with no protection (e.g., see the area 87 as compared to adjacent areas of channels 83e and 83f).

For all embodiments herein, the amount of formation protective materials used is an effective amount to achieve the desired amount and location of formation protection. In certain aspects, the formation protective materials used are in an aqueous solution; in certain aspects, between 30 to 45 weight percent of an aqueous solution (“FPM solution;” percent by weight of material in water for each gallon of solution). Depending on the amount and location of protection desired, in certain aspects, for 1000 gallons of fluid pumped into an earth formation, there is between 0.1 to 2.0 gallons of FPM solution. In certain aspects, between 0.25 to 0.50 gallons of FPM solution per 1000 gallons of pumped fluid; and in other aspects, between 1.0 to 2.0 gallons of FPM solution per 1000 gallons of pumped fluid. In certain aspects, the pumped fluid is a fraccing fluid.

It is noted that certain changes can be made in the subject matter disclosed without departing from the spirit and the scope of this invention. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. All patents and applications identified herein are incorporated fully herein for all purposes. In this patent document, the word “comprising” is used in its non-limiting sense to mean that items following the word are included, but items not specifically mentioned are not excluded.

What is claimed is:

1.-50. (canceled)

51. A method comprising:
contacting a permeable treatment zone in fluid communication between a wellbore and a fluid reservoir with a treatment fluid comprising a clay stabilizer and formation protective material,
with sufficient clay stabilizer and sufficient formation protective material and for a period of time effective to inhibit fines production and migration in the permeable treatment zone,
said formation protective material comprising a water soluble metal salt.

52. The method of claim 51 wherein the water soluble metal salt is one of cationic metal salts, water-soluble aluminum salts, aluminum chloride, aluminum chlorohydrates, cloroaluminate, zirconium chlorides, zirconium tetrachloride, zirconocene dichloride, zirconium (III) chloride, zirconium salts and aluminum zirconium tetracholorhydrex glycine.

53. The method of claim 51 further including
applying the formation protective material to an interior surface of earth at the permeable treatment zone to selectively locate a fracture therein.

54. A method comprising:
contacting a permeable treatment zone in fluid communication between a wellbore and a fluid reservoir in an earth formation with a treatment fluid comprising formation protective material and a clay stabilizer for a period of time effective to inhibit fines migration in the treatment zone; and, thereafter
displacing a second fluid through the treatment zone between the wellbore and the reservoir,
the formation protective material comprising one or a combination of water-soluble metal salts, cationic metal salts, water-soluble aluminum salts, aluminum chloride, aluminum chlorohydrates, cloroaluminate, zirconium chlorides, zirconium tetrachloride, zirconocene dichloride, zirconium (III) chloride, zirconium salts and aluminum zirconium tetracholorhydrex glycine.

55. the method of claim 54 wherein the treatment fluid is a saline treatment fluid, the clay stabilizer is a poly(oxyalkylene) polyamine, and the second fluid entering the treatment zone comprises an aqueous phase essentially free of the clay stabilizer.

56. The method of claim 55 wherein the saline treatment fluid comprises the clay stabilizer in an amount from about 0.1 to about 10 weight percent by weight of the liquid phase.

57. The method of claim 37 or 38 further comprising hydraulically fracturing the formation.

58. The method of claim 57 further comprising hydraulically fracturing the formation wherein a fluid in each of a plurality of fluid injection stages comprises the saline treatment fluid.

59. The method of claim 55 wherein the saline treatment fluid comprises one of: a carrier for the gravel for gravel packing, a prepad, and a preflush in an operation to treat the formation.

60. The method of claim 54 wherein the formation protective material (“FPM”) is present in an amount that is one of:
the ratio of FPM to other material is −0.1 to 1000; a ratio of 0.1 gallons to 1000 gallons; a ratio of between 0.1 and 0.5 FPM to 1000 other material; in certain aspects, a ratio of between 0.1 and 0.5 gallons FPM to 1000 gallons other material; a ratio of 1:1000; a ratio of 1 gallon of FPMs to 1000 gallons of other material a ratio of between 0.1 to 2.0 of FPM to 1000 of other material; in a ratio of between 0.1 to 2.0 gallons of FPM to 1000 gallons of other material; a ratio of between 0.25 and 0.50 FPM to 1000 other material; a ratio of between 0.25 and 0.50 gallons FPM to 1000 gallons other material; from about 0.01 g/L of fluid (0.1 lb/1000 gal of fluid (ppt)) to less than about 7.2 g/L (60 ppt), from about 0.018 to about 4.8 g/L (about 1.5 to about 40 ppt), from about 0.018 to about 4.2 g/L (about 1.5 to about 35 ppt), from 0.018 to about 3 g/L (1.5 to about 25 ppt), from about 0.24 to about 1.2 g/L , about 2 to about 10 ppt. from 0.01 to 0.4 percent by weight of a fluid, from 0.025 to 0.2 percent by weight of a fluid, at a rate within a range of from any lower limit selected from 0.0001, 0.001, 0.01, 0.025, 0.05, 0.1, ; 0.2 percent by weight of a liquid phase, up to any higher upper limit selected from 1.0, 0.5, 0.4, 0.25, 0.2, 0.15, 0.1 percent by weight of the liquid phase; and FPM from about 1% to about 10% by volume based upon total fluid volume 100%.

61. The method of claim 54 wherein the formation protective material is between 10 to 60 weight percent of the treatment fluid, weight percent being by weight of material in water for each gallon of fluid.

62. The method of claim 54 wherein the fluid protective material is. present as on of: about 32 weight percent, about 35 weight percent, and about 40 weight percent of the treatment fluid.

63. The method of claim 54 wherein the formation protective material is in fluid pumped into an earth formation and is present as between 0.1 to 2.0 gallons for each 1000 total gallons of fluid pumped into the earth formation.

64. The method of claim 54 wherein the step of contacting a permeable treatment zone is part of an operation that is one of an operation that is: drilling, injection, fracturing, testing, workover, completion, flushing, and treating.

65. The method of claim 54 wherein the treatment fluid is one of: workover fluid, fracturing fluid, flushing fluid, slickwater fluid, water-based fluids, drilling mud, cements, completion fluid, slurry, injection fluid, matrix treatment fluid, hydraulic fracturing fluid, stimulation fluid, isolation fluid, drill-in fluid, water-base fluid, pneumatic fluid, non-water-base fluid, remediation fluid, suspension, emulsion, fluid with proppants, and brine, and combinations thereof.

66. The method of claim 54 wherein the treatment fluid is a fracturing fluid that is one of: aqueous solution, gelled aqueous solution, aqueous acid solution, gelled aqueous acid solution, aqueous emulsion, and aqueous acid containing emulsion.

67. The method of claim 54 further comprising
creating a fracture in the earth formation, the fracture having an interior surface with fracture faces;
applying to said fracture faces the formation protective material;
injecting into the fracture a formation etching agent; and
wherein the formation etching agent etches fracture faces of the fracture so as to form a flow channel in the formation.

68. The method of claim 67 wherein wherein the formation etching agent is selected from: mineral acids and mixtures thereof, organic acids and mixtures thereof, mineral acids and mixtures of mineral acids mixed with gelling agent, organic acids and mixtures of organic acids mixed with gelling agent, water soluble hydroxides and mixtures of water soluble hydroxides, water soluble hydroxides and mixtures of water soluble hydroxides mixed with gelling agent hydrochloric acid, hydrofluoric acid, hydrochloric and hydrofluoric acid mixtures, hydrochloric acid mixed with gelling agent, hydrofluoric acid mixed with gelling agent, acetic acid, formic acid, acetic acid mixed with gelling agent, formic acid mixed with gelling agent, citric acid, alkali metal hydroxides and mixtures of alkali metal hydroxides, alkaline earth metal hydroxides and mixtures of alkaline earth metal hydroxides, lime and mixtures of lime with other basic metal oxides and hydroxides, alkali metal hydroxides and mixtures of alkali metal hydroxides mixed with gelling agent, alkaline earth metal hydroxides and mixtures of alkaline earth metal hydroxides mixed with gelling agent, lime and mixtures of lime with other basic metal oxides and hydroxides and gelling agent.

69. The method of claim 68 wherein the formation protective material is miscible with the formation etching agent.

70. A method comprising:
providing a treatment fluid including a carrier fluid with formation protective material therein,
injecting the treatment fluid into a subterranean formation, formation protective material applied to earth of the subterranean formation; and
acidizing at least a portion of the subterranean formation,
the formation protective material being one of or a combination of water-soluble metal salts, cationic metal
